(19) United States
(12) Patent Application Publication
(10) Pub. No.: US 2008/0067473 A1
(43) Pub. Date: Mar. 20, 2008

(54) LIQUID COMPOSITION FOR DEPOSITION OF ORGANIC ACTIVE MATERIALS

(76) Inventors: DENNIS D. WALKER, Santa Barbara, CA (US); Paul Anthony Sant, Santa Barbara, CA (US); Stephen Sorich, Goleta, CA (US); Charles D. MacPherson, Santa Barbara, CA (US); Alberto Goenaga, Goleta, CA (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 11/758,247

(22) Filed: Jun. 5, 2007

Related U.S. Application Data
(60) Provisional application No. 60/811,004, filed on Jun. 5, 2006.

(51) Int. Cl. C09K 11/06

(52) U.S. Cl. 252/301.16

(57) ABSTRACT

There is provided a composition for the liquid deposition of organic active materials. In the composition the organic active material is dispersed in a liquid medium. The liquid medium is made up of 5-35% by weight of a first liquid having a boiling point greater than 160° C. and 65-95% by weight of a second liquid having a boiling point less than 130° C.

### BACKGROUND INFORMATION

1. Field of the Disclosure

This disclosure relates in general to compositions for the liquid deposition of organic active materials.

2. Description of the Related Art

Organic electronic devices have attracted increasing attention in recent years. Examples of organic electronic devices include Organic Light Emitting Diodes (OLEDs). OLEDs are promising for display applications due to their high power conversion efficiency and low processing costs. When manufacturing full color displays, each display pixel can be divided into three subpixels, each emitting one of the three primary colors: red, green, and blue. A variety of deposition techniques can be used in forming layers used in OLEDs. Increasingly, liquid deposition techniques have been used, such as printing.

Techniques for printing layers include ink-jet printing and continuous printing. Ink-jet printing has been used extensively in the formation of full-color OLED displays due to its ability to dispense precise amounts of liquid. Ink-jet printers dispense liquids as drops. Continuous printing is just starting to become used in printing layers for electronic devices. Continuous printing can be performed using a printing head having a nozzle. The diameter of the nozzle can be in a range of approximately 10 to 50 microns.

However, in any liquid deposition method, the deposition of one layer may disrupt previously deposited layers. This can be a problem with the deposition of the three subpixel colors.

### SUMMARY

There is provided a composition comprising at least one organic active material dispersed in a liquid medium comprising 5-35% by weight of a first liquid having a boiling point greater than 160° C. and 65-95% by weight of a second liquid having a boiling point less than 130° C.

In one embodiment, the first liquid is a combination of liquids, each having a boiling point greater than about 170° C.

In one embodiment, the second liquid is a combination of liquids, each having a boiling point less than about 130° C.

In another embodiment, the composition comprises an electroluminescent material. In another embodiment, the composition comprises an electroluminescent material and a host material.

In still another embodiment, the composition comprises an active layer.

In a still further embodiment, an electronic device comprises an active layer comprising the composition.

The foregoing general description and the following detailed description are exemplary and explanatory only and are not restrictive of the invention, as defined in the appended claims.

### DETAILED DESCRIPTION

Many aspects and embodiments have been described above and are merely exemplary and not limiting. After reading this specification, skilled artisans appreciate that other aspects and embodiments are possible without departing from the scope of the invention.

Other features and benefits of any one or more of the embodiments will be apparent from the following detailed description, and from the claims. The detailed description first addresses Definitions and Clarification of Terms followed by the Liquid Materials, the Active Materials, Organic Electronic Devices, and finally, Examples.

### 1. DEFINITIONS AND CLARIFICATION OF TERMS

Before addressing details of embodiments described below, some terms are defined or clarified.

The term “active” when used in referring to a material or layer, is intended to mean a material which is electroactive, photoactive, or bioactive, and which exhibits the predetermined activity in response to a stimulus, such as an electromagnetic field, an electrical potential, solar energy radiation, a biostimulation field, or any combination thereof.

The term “photoactive” is intended to mean to any material that exhibits electroluminescence or photosensitivity.

The term “dispersed in a liquid medium” is intended to mean that a homogenous composition is formed. The term encompasses the formation of solutions, dispersions, and suspensions or emulsions.

The term “polymer” is intended to mean a material having at least one repeating monomeric unit. The term includes homopolymers having only one kind of monomeric unit, and copolymers having two or more different monomeric units. In one embodiment, a polymer has at least 5 repeating units.

The term “aromatic group” is intended to mean a substituent group derived from an aromatic compound. The term “aromatic compound” is intended to mean an organic compound comprising at least one unsaturated cyclic group having delocalized pi electrons. The term is intended to encompass both aromatic compounds having only carbon and hydrogen atoms, and heteroaromatic compounds wherein one or more of the carbon atoms within the cyclic group has been replaced by another atom, such as nitrogen, oxygen, sulfur, or the like.

The term “alkenyl” is intended to mean a group derived from a hydrocarbon having one or more carbon-carbon double bonds.

Unless otherwise indicated, all groups can be unsubstituted or substituted. In one embodiment, substituent groups include halide, alkyl, and cyano groups. Unless otherwise indicated, all groups can be linear, branched or cyclic, where possible.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of “a” or “an” are employed to describe elements and components described herein. This is done merely for convenience and to give a general sense of the scope of the invention. This description should be read to include one or at least one and the singular also includes the plural unless it is obvious that it is meant otherwise.

Group numbers corresponding to columns within the Periodic Table of the elements use the “New Notation” convention as seen in the CRC Handbook of Chemistry and Physics, 81^{st} Edition (2000-2001).

Unless otherwise defined, all technical and scientific terms used herein have the same meaning as commonly understood by one of ordinary skill in the art to which this invention belongs. Although methods and materials similar or equivalent to those described herein can be used in the practice or testing of embodiments of the present invention, suitable methods and materials are described below. All publications, patent applications, patents, and other references mentioned herein are incorporated by reference in their entirety, unless a particular passage is cited In case of conflict, the present specification, including definitions, will control. In addition, the materials, methods, and examples are illustrative only and not intended to be limiting.

To the extent not described herein, many details regarding specific materials, processing acts, and circuits are conventional and may be found in textbooks and other sources within the organic light-emitting diode display, photodetector, photovoltaic, and semiconductive member arts.

### 2. LIQUID MATERIALS

The liquid medium comprises a first liquid, which is a higher boiling component, and a second liquid, which is a lower boiling component.

The first liquid has a boiling point greater than about 160° C. In one embodiment, the boiling point is greater than about 170° C. In one embodiment, the first liquid is an aromatic liquid. In one embodiment, the first liquid is selected from lower alkyl substituted anisole. In one embodiment, the first liquid is an anisole having one, two, or three methyl substitutents. In one embodiment, the first liquid is dimethylanisole.

In one embodiment, the first liquid is a combination of liquids, each having a boiling point greater than about 170° C.

In one embodiment, the first liquid is present in the liquid medium at a concentration of about 5-35% by weight. In one embodiment, the first liquid is 10-20% by weight.

The second liquid has a boiling point less than about 130° C. In one embodiment, the boiling point is less than about 120° C. In one embodiment, the second liquid is an aromatic liquid. In one embodiment, the second liquid is selected from benzene and its derivatives and toluene and its derivatives. In one embodiment, the second liquid is selected from fluorobenzene, difluorobenzene, toluene, and trifluorotoluene. In one embodiment, the second liquid is toluene.

In one embodiment, the second liquid is a combination of liquids, each having a boiling point less than about 130° C.

In one embodiment, the second liquid is present in the liquid medium at a concentration of about 65-95% by weight. In one embodiment, the first liquid is 80-90% by weight.

### 3. THE ORGANIC ACTIVE MATERIAL

The organic active material is one which is electroactive, photoactive, or bioactive. Examples of organic active materials include, but are not limited to charge transport materials, conductive and semiconductive materials. The term “charge transport,” when referring to a layer, material, member, or structure is intended to mean such layer, material, member, or structure facilitates migration of such charge through the thickness of such layer, material, member, or structure with relative efficiency and small loss of charge.

In one embodiment, the active material is a photoactive material. In one embodiment, the active material is an electroluminescent material. Electroluminescent (“EL”) materials include small molecule organic fluorescent compounds, fluorescent and phosphorescent metal complexes, conjugated polymers, and mixtures thereof. Examples of fluorescent compounds include, but are not limited to, pyrene, perylene, rubrene, coumarin, derivatives thereof, and mixtures thereof. Examples of metal complexes include, but are not limited to, metal chelated oxinoid compounds, such as tris(8-hydroxyquinolato)aluminum (Alq3); cyclometalated iridium and platinum electroluminescent compounds, such as complexes of iridium with phenylpyridine, phenylquinoline, phenylisoquinoline, or phenylpyrimidine ligands as disclosed in Petrov et al., U.S. Pat. No. 6,670,645 and Published PCT Applications WO 03/063555 and WO 2004/016710, and organometallic complexes described in, for example, Published PCT Applications WO 03/008424, WO 03/091688, and WO 03/040257, and mixtures thereof. Examples of conjugated polymers include, but are not limited to poly(phenylenevinylenes), polyfluorenes, poly(spirobifluorenes), polythiophenes, poly(p-phenylenes), copolymers thereof, and mixtures thereof.

In some embodiments, the EL material is present with a host material. In some embodiments, the host is a charge carrying material. In an EL/host system, the EL material can be a small molecule or polymer and the host can be independently a small molecule or polymer.

In some embodiments, the EL material is a cyclometalated complex of iridium. In some embodiments, the complex has two ligands selected from phenylpyridines, phenylquinolines, and phenylisoquinolines, and a third ligand with is a β-dienolate. The ligands may be unsubstituted or substituted with F, D, alkyl, CN, or aryl groups.

In some embodiments, the EL material is a polymer selected from the group consisting of poly(phenylenevinylenes), polyfluorenes, and polyspirobifluorenes.

In some embodiments, the EL material is selected from the group consisting of a non-polymeric spirobifluorene compound and a fluoranthene compound.

In some embodiments, the EL material is a compound having aryl amine groups. In one embodiment, the EL material is selected from the formulae below: 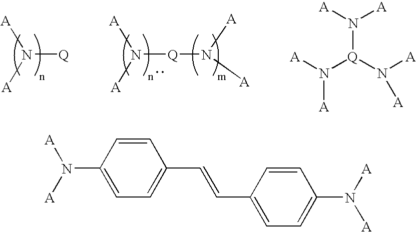
where:

A is the same or different at each occurrence and is an aromatic group having from 3-60 carbon atoms;

Q is a single bond or an aromatic group having from 3-60 carbon atoms;

n and m are independently an integer from 1-6.

In one embodiment of the above formula, at least one of A and Q in each formula has at least three condensed rings. In one embodiment, m and n are equal to 1. In one embodiment, Q is a styryl or styrylphenyl group.

In one embodiment, the EL material has the formula below: 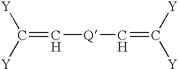
where:

Y is the same or different at each occurrence and is an aromatic group having 3-60 carbon atoms;

Q′ is an aromatic group, a divalent triphenylamine residue group, or a single bond.

In one embodiment, the host is a bis-condensed cyclic aromatic compound

In one embodiment, the host is anthracene derivative compound. In one embodiment the compound has the formula:
An-L-An
where:

An is an anthracene moiety;

L is a divalent connecting group.

In one embodiment of this formula, L is a single bond, —O—, —S—, —N(R)—, or an aromatic group. In one embodiment, An is a mono- or diphenylanthryl moiety.

In one embodiment, the host has the formula:
A-An-A
where:

An is an anthracene moiety;

A is an aromatic group.

In one embodiment, the host has the formula: 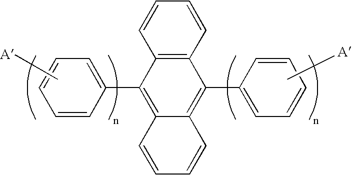
where:

A′ is the same or different at each occurrence and is an aromatic group or an alkenyl group;

n is the same or different at each occurrence and is an integer from 1-3.

Some specific examples blue EL materials are:

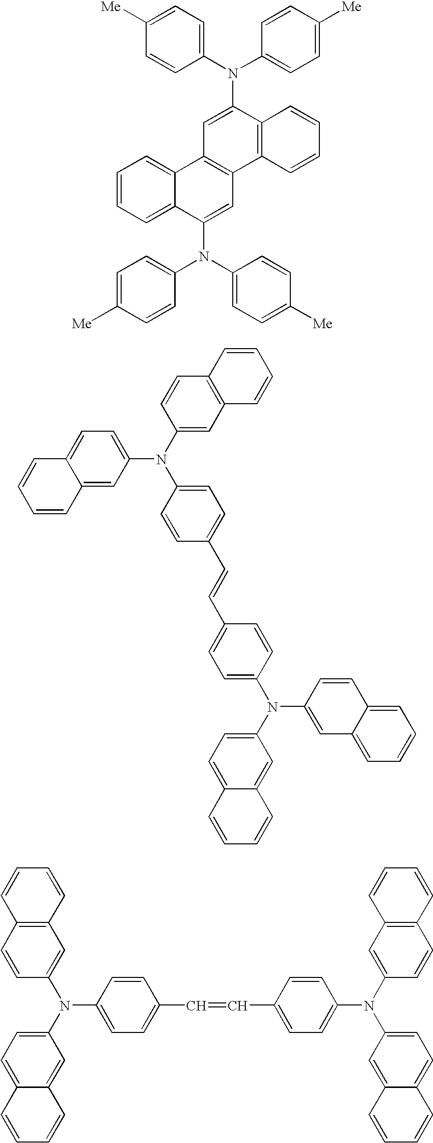

One example of a green EL material is: 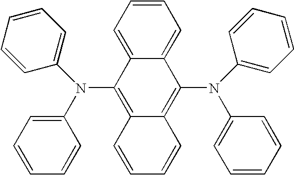
This green El compound may also have one or more methyl substituents.

One example of a red EL material is:

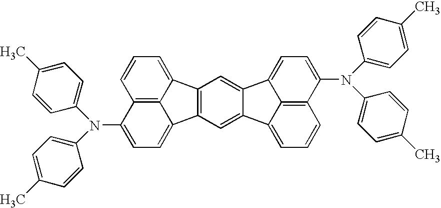

Some examples of host materials are:

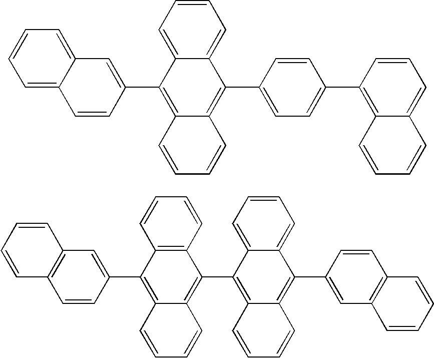

### 4. ORGANIC ELECTRONIC DEVICE

The liquid compositions of organic active materials described herein can be used to form layers in any type of electronic device. The compositions are advantageously used to form layers without disturbing previously formed layers. The term “layer” is used interchangeably with the term “film” and refers to a coating covering a desired area. The term is not limited by size. In electronic displays, for example, the area can be as large as an entire device or as small as a specific functional area such as an actual visual display, or as small as a single sub-pixel. The layers can be formed by any conventional liquid deposition technique, including continuous and discontinuous techniques. Continuous deposition techniques, include but are not limited to, spin coating, gravure coating, curtain coating, dip coating, slot-die coating, spray coating, and continuous nozzle coating. Discontinuous deposition techniques include, but are not limited to, ink jet printing, gravure printing, and screen printing.

Examples of organic electronic devices include, but are not limited to: (1) a device that converts electrical energy into radiation (e.g., a light-emitting diode, light emitting diode display, diode laser, or lighting panel), (2) a device that detects a signal using an electronic process (e.g., a photodetector, a photoconductive cell, a photoresistor, a photoswitch, a phototransistor, a phototube, an infrared (“IR”) detector, or a biosensors), (3) a device that converts radiation into electrical energy (e.g., a photovoltaic device or solar cell), (4) a device that includes one or more electronic components that include one or more organic semiconductor layers (e.g., a transistor or diode), or any combination of devices in items (1) through (4). The solid conductive polymer compositions described herein can be used to form any conductive or semiconductive layer in these devices.

Organic light-emitting diodes (OLEDs) are an organic electronic device comprising an organic layer capable of electroluminescence. OLEDs containing conducting polymers can have the following configuration:
anode/buffer layer/EL material/cathode
   The anode is typically any material that is transparent and has the ability to inject holes into the EL material, such as, for example, indium/tin oxide (ITO). The anode is optionally supported on a glass or plastic substrate. EL materials include fluorescent compounds, fluorescent and phosphorescent metal complexes, conjugated polymers, and mixtures thereof. The cathode is typically any material (such as, e.g., Ca or Ba) that has the ability to inject electrons into the EL material.

In one embodiment, at least one of the subpixel colors of red, green and blue, is deposited from a liquid composition comprising the EL material dispersed in a liquid medium comprising 5-35% by weight of a first liquid having a boiling point greater than 160° C. and 65-95% by weight of a second liquid having a boiling point less than 130° C. In one embodiment, at least two of the subpixel colors are deposited from a liquid medium comprising 5-35% by weight of a first liquid having a boiling point greater than 160° C. and 65-95% of a second liquid having a boiling point less than 130° C.

### EXAMPLES

The concepts described herein will be further described in the following examples, which do not limit the scope of the invention described in the claims.

### Example 1

Note that not all of the activities described above in the general description or the examples are required, that a portion of a specific activity may not be required, and that one or more further activities may be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

It is to be appreciated that certain features are, for clarity, described herein in the context of separate embodiments, may also be provided in combination in a single embodiment. Conversely, various features that are, for brevity, described in the context of a single embodiment, may also be provided separately or in any subcombination. Further, reference to values stated in ranges include each and every value within that range.

What is claimed is:

1. A composition comprising at least one organic active material dispersed in a liquid medium comprising 5-35% by weight of a first liquid having a boiling point greater than 160° C. and 65-95% by weight of a second liquid having a boiling point less than 130° C.

2. The composition of claim 1, wherein the organic active material is a photoactive material.

3. The composition of claim 1, wherein the first liquid is an aromatic compound.

4. The composition of claim 3, wherein the first liquid is a lower alkyl substituted anisole.

5. The composition of claim 4, wherein the first liquid is selected from the group consisting of methylanisole, dimethylanisole, and trimethylanisole.

6. The composition of claim 1, wherein the first liquid and the second liquid are aromatic compounds.

7. The composition of claim 3, wherein the second liquid is also an aromatic compound.

8. The composition of claim 1, wherein the second liquid is selected from the group consisting of fluorobenzene, difluorobenzene, toluene, and trifluorotoluene.

9. The composition of claim 1, wherein the organic active material comprises an electroluminescent compound and a host compound.

10. The composition of claim 9, wherein the electroluminescent compound is selected from the following formulae: 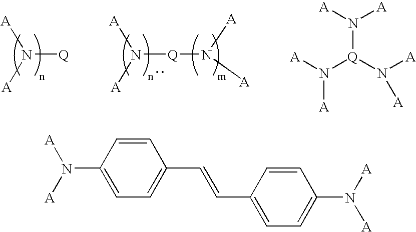
where:
A is the same or different at each occurrence and is an aromatic group having from 3-60 carbon atoms;
Q is a single bond or an aromatic group having from 3-60 carbon atoms;
n and m are independently an integer from 1-6; and 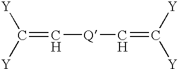
where:
Y is the same or different at each occurrence and is an aromatic group having 3-60 carbon atoms;
Q′ is an aromatic group, a divalent triphenylamine residue group, or a single bond.

11. The composition of claim 10, wherein the electroluminescent compound is one of the following compounds:

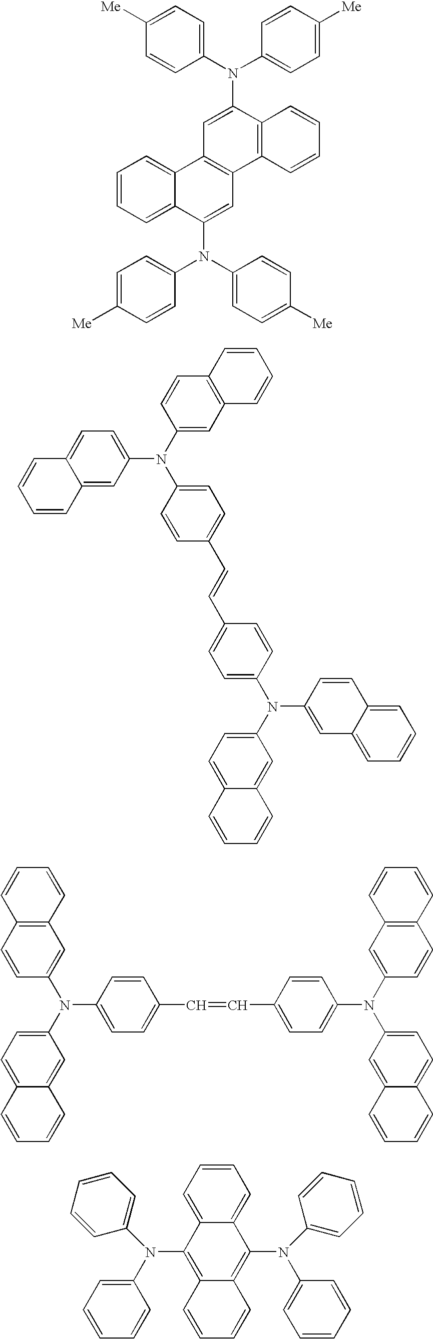

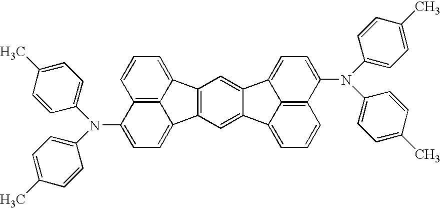

12. The composition of claim 9, wherein the host compound has the formula:
An-L-An
where:
An is an anthracene moiety;
L is a divalent connecting group.

13. The composition of claim 9, wherein the host compound has the formula,
A-An-A
where:
An is an anthracene moiety;
A is an aromatic group.

14. The composition of claim 9, wherein the host compound has the formula, 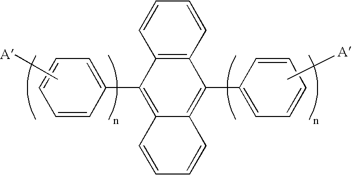
where:
A′ is the same or different at each occurrence and is an aromatic group or an alkenyl group;
n is the same or different at each occurrence and is an integer from 1-3.

15. The composition of claim 9, wherein the host compound is one of the following compounds:

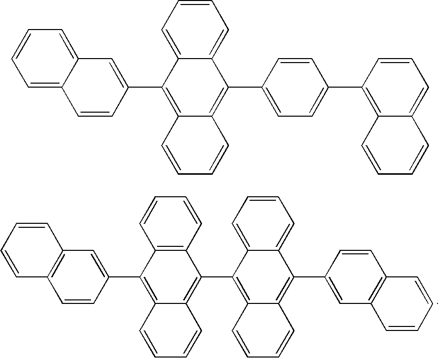

16. The composition of claim 1, wherein the first liquid is a combination of liquids, each having a boiling point greater than 170° C.

17. The composition of claim 1, wherein the second liquid is a combination of liquids, each having a boiling point less than 130° C.

18. An active layer comprising a composition of claim 1.

19. A device comprising an active layer comprising a composition of claim 1.
